(19) United States
(12) Patent Application Publication
(10) Pub. No.: US 2025/0358481 A1
(43) Pub. Date: Nov. 20, 2025

(54) VIDEO PROCESSING

(71) Applicant: Beijing Youzhuju Network Technology Co., Ltd., Beijing (CN)

(72) Inventors: Minjie Xie, Beijing (CN); Xiaoqing Guan, Beijing (CN); Chao Gao, Beijing (CN); Jingyi Zhu, Beijing (CN); Chunyi Huang, Beijing (CN); Xiaoyun Song, Beijing (CN)

(21) Appl. No.: 18/969,958

(22) Filed: Dec. 5, 2024

(30) Foreign Application Priority Data
May 17, 2024 (CN) 202410620324.9

(51) Int. Cl. H04N 21/472; H04N 21/431; H04N 21/442

(52) U.S. Cl. CPC H04N 21/47217; H04N 21/4316; H04N 21/44204

(57) ABSTRACT

The disclosure provides a method, apparatus, device and storage medium for video processing, and the method includes: firstly, displaying a target page including a first page area and a second page area, playing a target video in the first page area, and presenting at least one fragment information corresponding to the target video in the second page area, wherein the fragment information presented in the second page area has a correspondence with a target video fragment in the target video.

### CROSS-REFERENCE

The present application claims priority to Chinese Patent Application No. 202410620324.9, filed on May 17, 2024, and entitled “METHOD, APPARATUS, DEVICE AND STORAGE MEDIUM FOR VIDEO PROCESSING”, the entirety of which is incorporated herein by reference.

### FIELD

The present disclosure relates to a field of data processing, and in particular, to video processing.

### BACKGROUND

With the continuous development of video processing technologies, users have increasingly diversified demands on video processing related functions.

Therefore, how to enrich video processing related functions to meet the growing and diverse needs of users has become a technical problem to be solved urgently.

### SUMMARY

Embodiments of the present disclosure provide a method, apparatus, device and storage medium for video processing.

According to a first aspect, the present disclosure provides a method for video processing, including:
displaying a target page, wherein the target page includes a first page area and a second page area; and
playing a target video in the first page area and presenting at least one fragment information corresponding to the target video in the second page area, wherein each of the fragment information has a correspondence with a target video fragment in the target video, the fragment information corresponding to the target video fragment reflecting content attribute information of a preset type of the target video fragment.

In an optional implementation, the method further includes:
adjusting, in response to the target video being played to a first target video fragment, a display position of first fragment information corresponding to the first target video fragment to a first target presentation position in the second page area.

In an optional implementation, the method further includes:
adjusting, in response to a preset trigger operation for second fragment information in the second page area, a playback progress of the target video in the first page area to a second target video fragment corresponding to the second fragment information.

In an optional implementation, adjusting, in response to a preset trigger operation for second fragment information in the second page area, a playback progress of the target video in the first page area to a second target video fragment corresponding to the second fragment information includes:
in response to the preset trigger operation for the second fragment information in the second page area, adjusting a display position of the second fragment information to a second target presentation position in the second page area, and adjusting the playback progress of the target video in the first page area to the second target video fragment corresponding to the second fragment information.

In an optional implementation, the content attribute information of the preset type comprises fragment description information and/or fragment interpretation information of the target video fragment, the fragment description information describing an attribute feature of the target video fragment, and the fragment interpretation information reflecting a content feature of the target video fragment,
wherein the fragment description information comprises at least one of playback time information, a video picture, or video interaction data of the target video fragment,
wherein the fragment interpretation information comprises fragment digest information corresponding to the target video fragment and/or object description manner information corresponding to the target video fragment, wherein the fragment digest information is obtained by performing digest extraction on target text information, the target text information being obtained by performing speech recognition on the target video fragment, or the fragment digest information is text information obtained by performing speech recognition on the target video fragment, the object description manner information representing a description manner of a recommended object in the target video fragment.

In an optional implementation, the playback time information comprises playback start and end times of the target video fragment, and/or
the video picture comprises an initial frame video picture in the target video fragment, and/or
the video interaction data comprises an amount of user views and/or user usage, and/or
the fragment digest information comprises target text content displayed in a preset manner, the target text content describing a feature of the recommended object in the target video fragment.

In an optional implementation, the target page further includes a third page area, and the method further includes:
displaying a current playback time point of the target video and first indicator data corresponding to the current playback time point in the third page area, wherein the first indicator data belongs to a first data indicator item.

In an optional implementation, a data trend graph corresponding to the first data indicator item is presented within the third page area, the data trend graph reflecting a data change status of the target video for the first data indicator item.

In an optional implementation, a plurality of data indicator items is presented within the third page area, and the method further comprises:
switching, in response to a trigger operation to switch from the first data indicator item to a second data indicator item, the first indicator data in the third page area to display second indicator data corresponding to the current playback time point of the target video, wherein the second indicator data belongs to the second data indicator item.

In an optional implementation, a playback time axis of the target video is displayed on the target page, and a playback start time point corresponding to the target video fragment in the target video is marked on the playback time axis, and/or
the target video fragments corresponding to respective fragment information presented in the second page area are different, and/or
the target video fragment is a video fragment of which target indicator data meets a preset condition, the target indicator data being determined based on indicator data of a preset type during a playback period of the video fragment.

According to a second aspect, the present disclosure provides an apparatus for video processing, including:
a first display module configured for displaying a target page, wherein the target page includes a first page area and a second page area; and
a first presentation module configured for playing a target video in the first page area and presenting at least one fragment information corresponding to the target video in the second page area, wherein each of the fragment information has a correspondence with a target video fragment in the target video, the fragment information corresponding to the target video fragment reflecting content attribute information of a preset type of the target video fragment.

According to a third aspect, the present disclosure provides a computer-readable storage medium, where the computer-readable storage medium stores an instruction, when the instruction runs on a terminal device, causing the terminal device to implement the foregoing method.

According to a fourth aspect, the present disclosure provides a device for video processing, including: a memory, a processor, and a computer program stored in the memory and executable on the processor, the processor executing the computer program to implement the foregoing method.

According to a fifth aspect, the present disclosure provides a computer program product, where the computer program product includes a computer program/instruction, the computer program/instruction, when executed by a processor, implementing the foregoing method.

### BRIEF DESCRIPTION OF THE DRAWINGS

The drawings herein are incorporated in this specification and constitute a part of this specification, illustrating embodiments consistent with the present disclosure and, in conjunction with the specification, explaining the principles of the present disclosure.

In order to provide a clearer explanation of the technical solutions of embodiments of the present disclosure or technologies in the prior art, a brief introduction will be given below to the accompanying drawings used for describing embodiments or technologies in the prior art, it is obvious that for those skilled in the art, other accompanying drawings may be obtained based on these accompanying drawings without any creative work.

FIG. 1 is a flowchart of a method for video processing according to some embodiments of the present disclosure;

FIG. 2 is a schematic diagram of a target page according to some embodiments of the present disclosure;

FIG. 3 is a schematic diagram of a target page according to some embodiments of the present disclosure;

FIG. 4 is a schematic diagram of a target page according to some embodiments of the present disclosure;

FIG. 5 is a schematic diagram of a target page according to some embodiments of the present disclosure;

FIG. 6 is a schematic diagram of a target page according to some embodiments of the present disclosure;

FIG. 7 is a schematic structural diagram of an apparatus for video processing according to some embodiments of the present disclosure; and

FIG. 8 is a schematic structural diagram of a device for video processing according to some embodiments of the present disclosure.

### DETAILED DESCRIPTION

In order to be able to more clearly understand the above purposes, features and advantages of the present disclosure, the solutions of the present disclosure will be further described below. It is to be noted that, without confliction, embodiments and features in embodiments of the present disclosure may be combined with each other.

Many specific details are set forth in the following description to facilitate a thorough understanding of the present disclosure, but the present disclosure may also be implemented in ways other than those described herein; it is apparent that embodiments in the specification are only part of embodiments of the present disclosure, not all embodiments.

With the continuous development of video processing technologies, users have increasingly diversified demands on video processing related functions.

Therefore, how to enrich video processing related functions to meet the growing and diverse needs of users has become a technical problem to be solved urgently.

In view of this, embodiments of the present disclosure provide a method for video processing, and the method comprises: firstly, displaying a target page comprising a first page area and a second page area, playing a target video in the first page area, and presenting at least one fragment information corresponding to the target video in the second page area, wherein the fragment information presented in the second page area has a correspondence with a target video fragment in the target video. Therefore, in the process of playing the target video on the target page, embodiments of the present disclosure can present the fragment information corresponding to each target video fragment in the target video on the same page. Based on this, embodiments of the present disclosure support the user to browse the fragment information corresponding to each target video fragment in the process of watching the target video, thereby enriching video processing-related functions and improving user experience.

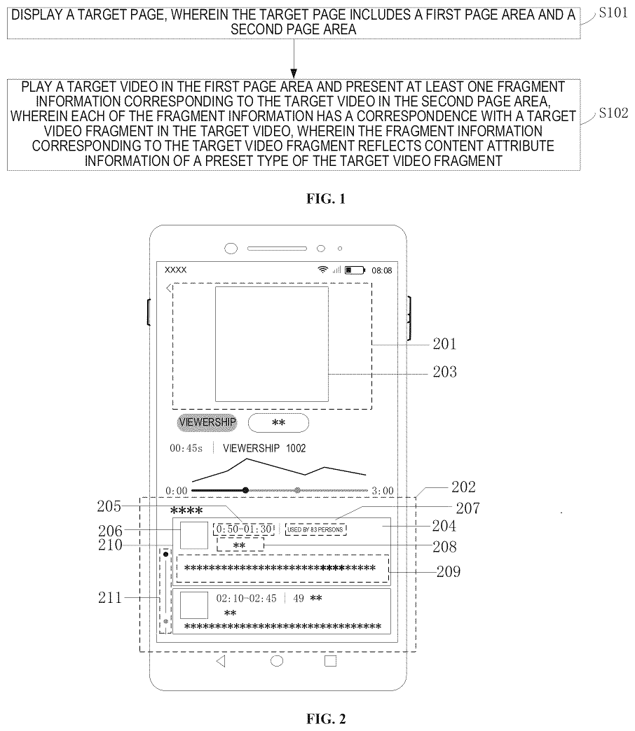

Specifically, embodiments of the present disclosure provide a method for video processing. FIG. 1 is a flowchart of a method for video processing according to an embodiment of the present disclosure. As shown, at S101, a target page is displayed. The target page includes a first page area and a second page area.

The method for video processing provided in embodiments of the present disclosure may be applied to a client. The client may be deployed at a terminal such as a smartphone or a tablet computer, and the like.

The target page in embodiments of the present disclosure may be any display page, and specifically, the target page includes at least a first page area and a second page area. The first page area and the second page area may be any display area predetermined on the target page.

A schematic diagram of a target page according to an embodiment of the present disclosure is shown in FIG. 2. The target page includes a first page area 201 and a second page area 202.

S102: a target video is played in the first page area and at least one fragment information corresponding to the target video is presented in the second page area. Each of the fragment information has a correspondence with a target video fragment in the target video. The fragment information corresponding to the target video fragment reflects content attribute information of a preset type of the target video fragment.

In an embodiment of the present disclosure, the target video may include at least one target video fragment. The target video fragment is a video fragment of which target indicator data meets a preset condition. The target indicator data is determined based on preset indicator data during a playback period of the video fragment. The preset indicator data may be any preset indicator data. Specifically, the preset indicator data may be user interaction data, for example, user order data, etc. The target indicator data meets a preset condition during the playback period of the video fragment. The preset condition may be a preset number threshold of the indicator data. That is, within the playback period of certain video fragment, if the preset indicator data meets the preset number threshold, the video fragment is regarded as the target video fragment. If the preset indicator data does not meet the preset number threshold, the video fragment is a non-target video fragment.

In an optional implementation, the target video fragment included in the target video may be predetermined by the poster of the target video, or may be determined from the target video by the server based on the model after the target video is posted. Specifically, after receiving the target video, the server analyzes content of the target video by using a preset model; identifies, based on the preset indicator data, a video fragment of which the preset indicator data meets a preset condition in the target video; and uses the identified video fragment as the target video fragment included in the target video. For example, the target video fragment may include a highlight video fragment in the target video. The highlight video fragment includes content that has a high probability of belonging to a point of interest of a video browsing user. The highlight video fragment is usually used to improve user interaction data of the target video, for example, increase an amount of user views and clicks of the target video.

Each of the fragment information in embodiments of the present disclosure has a correspondence with a target video fragment in the target video. Specifically, the target video fragments corresponding to respective fragment information presented in the second page area are different, that is, one fragment information may correspond to one target video fragment, and each fragment information may be determined based on the corresponding target video fragment. The fragment information corresponding to the target video fragment reflects content attribute information of the preset type of the target video fragment.

In the target page shown in FIG. 2, a target video 203 is played in the first page area 201, and at least one fragment information is presented within the second page area 202, including fragment information 204.

In embodiments of the present disclosure, the at least one fragment information presented within the second page area of the target page reflects content attribute information of a preset type of the target video fragment.

In an optional implementation, the content attribute information of the preset type includes fragment description information and/or fragment interpretation information of the target video fragment.

Herein, the fragment description information describes an attribute feature of the target video fragment. Specifically, the fragment description information may include at least one of playback time information, a video picture, or video interaction data of the target video fragment. The playback time information may specifically include playback start and end times of the target video fragment, representing playback positions of the target video fragment in the target video. The video picture may specifically include an initial frame video picture in the target video fragment, that is, a video frame corresponding to the playback start time of the target video fragment. The video interaction data may include interaction behavior data during a playback period corresponding to the target video fragment, and may specifically include an amount of user views, clicks, collections, and likes for the target video fragment, and an amount of user usage of the video created by using the target video fragment, and the like.

The fragment interpretation information reflects a content feature of the target video fragment. The fragment interpretation information may include fragment digest information corresponding to the target video fragment and/or object description manner information corresponding to the target video fragment. The object description manner information represents a description manner of the recommended object in the target video fragment, that is, a description manner and description skill used in the description of the recommended object in the target video fragment improve user interaction data.

In an optional implementation, the obtaining of the fragment digest information may include: performing speech recognition on the target video fragment by using a speech recognition tool, obtaining target text information of the target video fragment based on the speech recognition, and extracting key information such as an abstract part in the target text information by using an information extraction tool as the fragment digest information.

In another optional implementation, the obtaining of the fragment digest information may further include: performing speech recognition on the target video fragment by using a speech recognition tool, and directly using the text information obtained by the speech recognition as the fragment digest information.

In addition, the fragment digest information may also be obtained from subtitles in the target video fragment.

On the basis that the content attribute information of the preset type includes the fragment description information and/or the fragment interpretation information of the target video fragment, the content attribute information of the preset type may further include a video shooting manner, to describe a shooting manner of the content in the target video fragment, for example, a transition manner.

In order to prompt part of content in the content attribute information of the preset type, embodiments of the present disclosure may display the target text content in the fragment digest information in a preset manner when displaying the content attribute information of the preset type. The preset manner may highlight the target text content, for example, highlight the target text content in the fragment digest information. The target text content is used to describe content that needs to be highlighted for the user in the target video fragment. For example, the target text content may include features of the recommended object included in the target video fragment, such as selling point information of the recommended object, and the like.

For example, the fragment information 204 is displayed within the second page area in the target page shown in FIG. 2. The fragment description information corresponding to the target video fragment is presented in the fragment information 204. The fragment description information 204 specifically includes playback start and end times 205, a video picture 206, and video interaction data 207 corresponding to the target video fragment, and the fragment interpretation information corresponding to the target video fragment is also presented. The fragment interpretation information specifically includes object description manner information 208 and fragment digest information 209, where the target text content is highlighted in the fragment digest information 209.

In practical, to more clearly present the fragment information within the second page area, embodiments of the present disclosure may distinguish, within the second page area, fragment information corresponding to different target video fragments in a form of a resource card.

In the target page shown in FIG. 2, a resource card 210 is displayed within the second page area, and the fragment information 204 is presented on the resource card 210.

In addition, progress information may further be presented within the second page area to prompt the user about the display progress of the fragment information within the second page area. As shown in FIG. 2 progress information 211 is presented within the second page area in the target page.

In practical, in the process of playing the target video in the first page area of the target page, if it is monitored that the target video is played to the first target video fragment, the second page area may be controlled to display the first fragment information in a linkage manner corresponding to the first target video fragment, so that the user may also view corresponding fragment information while viewing the target video. The first target video fragment may be any target video fragment included in the target video, and the first target video fragment corresponds to the first fragment information.

According to embodiments of the present disclosure, by controlling the linkage display of each target video fragment in the target video and the corresponding fragment information, the user can conveniently check the fragment information related to the current video picture in the process of watching the target video, and the media content browsing experience of the user is improved.

Specifically, if it is monitored that the target video is played to the first target video fragment, the display position of the first fragment information corresponding to the first target video fragment is adjusted to a first target presentation position in the second page area. The first target presentation position may be any presentation position in the second page area. Specifically, the first target presentation position may be a top presentation position in the second page area. The user is prompted to view the first fragment information corresponding to the first target video fragment by sticking it on top in the second page area.

In an optional implementation, the presentation position of the first fragment information may be adjusted to the first target presentation position in the second page area by controlling the first fragment information presented in the second page area to slide up to the first target presentation position.

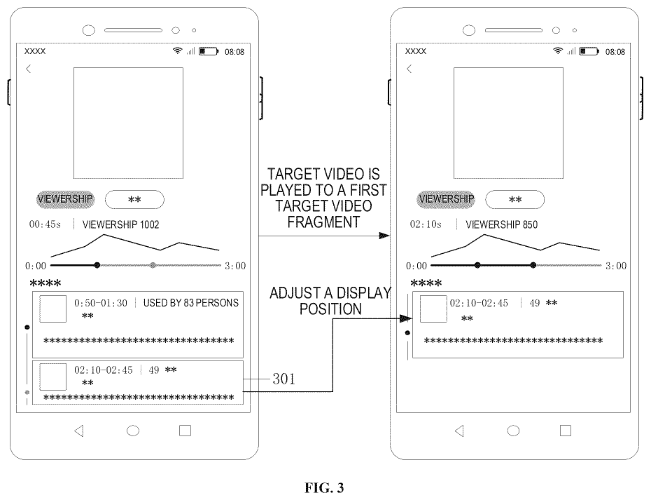

FIG. 3 is a schematic diagram of another target page provided for an embodiment of the present disclosure. If it is monitored that the target video is played to the first target video fragment, first fragment information 301 corresponding to the first target video fragment is displayed in the top area within the second page area, as shown in FIG. 3.

Based on the foregoing embodiments, in order to enrich the interaction manner related to the fragment information, for the fragment information presented in the second page area of the target page, embodiment of the present disclosure may also support a preset trigger operation for any of fragment information. The target video fragment corresponding to the information is displayed in a linkage manner within the first page area by triggering any of fragment information.

Specifically, if the preset triggering operation for the second fragment information in the second page area is received, the second target video fragment corresponding to the second fragment information is determined, and the playback progress of the target video in the first page area is adjusted to the second target video fragment, to implement content linkage display in the first page area and the second page area.

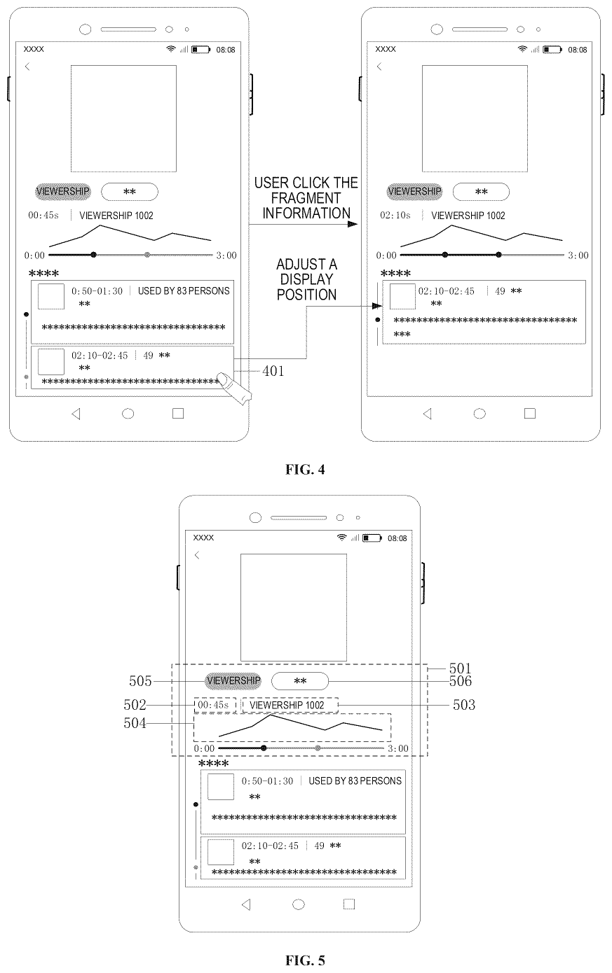

FIG. 4 is a schematic diagram of a further target page provided for an embodiment of the present disclosure. The second fragment information 401 is displayed within the second page area on the target page, and when a preset trigger operation for the second fragment information 401 is received, the second target video fragment corresponding to the second fragment information is determined, and the playback progress of the target video in the first page area is adjusted to the second target video fragment.

The second fragment information may be any fragment information within the second page area. For the preset triggering operation of the second fragment information within the second page area, the second fragment information may include a preset triggering operation such as a single click, a double click, and a long press for the second fragment information, and the like. The playback progress of the target video in the first page area is adjusted to the second target video fragment corresponding to the second fragment information. Specifically, the playback progress of the target video may be adjusted to the playback start time point of the second target video fragment.

On the basis that the playback progress of the target video is adjusted to the second target video fragment, in order to prompt the user to view the second fragment information corresponding to the second target video fragment, embodiments of the present disclosure may adjust the playback progress of the target video to the second target video fragment in response to receiving the preset triggering operation for the second fragment information, and control an adjustment of the display position of the second fragment information.

Specifically, if the preset trigger operation for the second fragment information in the second page area is received, the playback progress of the target video within the first page area is adjusted to the second target video fragment corresponding to the second fragment information, and the presentation position of the second fragment information is adjusted to the second target display position within the second page area. The second target presentation position may be any presentation position in the second page area. The second target presentation position may be the same as the first target presentation position or different from the first target presentation position. Specifically, the second target presentation position may be a top presentation position of the second page area.

FIG. 4 is a schematic diagram of a target page provided for an embodiment of the present disclosure. The second page area on the target page is displayed with the second fragment information 401. If a preset trigger operation for the second fragment information 401 is received, the display position of the second fragment information is adjusted to the top presentation position within the second page area.

In practical, in the process of playing the target video in the first page area on the target page and presenting the fragment information corresponding to the target video fragment in the second page area, the playback time axis of the target video may also be displayed on the target page. The playback time axis is used to display the playback progress of the target video. In addition, the playback time axis is further marked with the playback start time point corresponding to the target video fragment included in the target video, to prompt the user to watch the target video fragment.

In the method for video processing provided by embodiments of the present disclosure, firstly, a target page comprising a first page area and a second page area is displayed, a target video in the first page area is played, and at least one fragment information corresponding to the target video is presented in the second page area. The fragment information presented in the second page area has a correspondence with a target video fragment in the target video. Therefore, in the process of playing the target video on the target page, embodiments of the present disclosure can present the fragment information corresponding to each target video fragment in the target video on the same page. Based on this, embodiments of the present disclosure facilitate the user to browse the fragment information corresponding to each target video fragment in the process of watching the target video, thereby enriching video processing-related functions and improving user experience.

Based on the foregoing embodiments, in order to further enrich related functions of video processing, the target page in embodiments of the present disclosure may further include a third page area, and the third page area is used to present data information related to the target video.

Specifically, a current playback time point of the target video and first indicator data corresponding to the current playback time point are displayed in the third page area of the target page. If the playback time point of the target video is changed, and correspondingly, the displayed first indicator data is also updated accordingly. The first indicator data belongs to a first data indicator item, that is, the first indicator data is data under the first data indicator item. The first data indicator item is any preset data indicator item. The first data indicator item may be, for example, an amount of views, clicks, likes, or collections, and the like, and the first indicator data may be, for example, viewing data, clicking data, like data, collection data, and the like.

FIG. 5 is a schematic diagram of a target page provided for an embodiment of the present disclosure. The target page includes a third page area 501. A current playback time point 502 of the target video and first indicator data 503 corresponding to the current playback time point are displayed in the third page area 501.

In order to show a data trend of the first data indicator item more clearly, a data trend graph corresponding to the first data indicator item may also be presented within the third page area. The data change status for the first data indicator item in the target video may be reflected as a whole by displaying the data trend graph.

In the target page shown in FIG. 5, a data trend graph 504 is presented in the third page area 501, and the data trend graph may reflect a data change status for the first data indicator item in the target video.

Based on the foregoing embodiments, one or more data indicator items may also be presented within the third page area of the target page, and the data indicator item may reflect the indicator data change status of the target video at the current playback time point. The plurality of data indicator items respectively correspond to respective indicator data. The data indicator item may specifically include an amount of user views, clicks, likes, or collections, and the like.

In the target page shown in FIG. 5, a data indicator item 505 and a data indicator item 506 are presented within the third page area 501. The first indicator data 503 belongs to the data indicator item 505. In this case, the data indicator item 505 is the first data indicator item, and the data trend graph 504 corresponds to the data indicator item 505. The data trend graph 504 may reflect the data change status of the data indicator item 505 in the target video.

In practical, in order to present indicator data change status of the target video from a plurality of dimensions, embodiments of the present disclosure may also set a switching operation for the data indicator item.

In an optional implementation, if a trigger operation for switching from the first data indicator item to the second data indicator item is received, the first indicator data in the third page area is switched to the second indicator data corresponding to the current playback time point of the target video, where the second indicator data belongs to the second data indicator item. The second data indicator item is any data indicator item other than the first data indicator item. In addition, the data trend graph corresponding to the first data indicator item in the third page area is also switched to display a data trend graph corresponding to the second data indicator item.

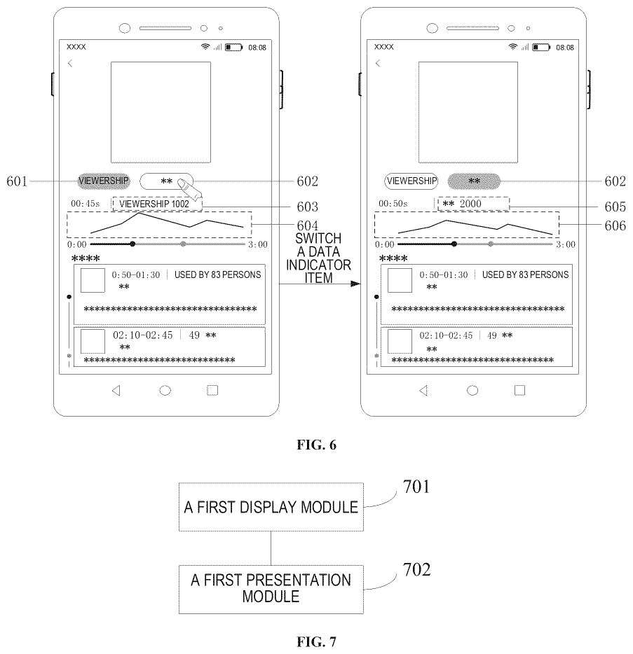

FIG. 6 is a schematic diagram of a target page provided for embodiments of the present disclosure. Within a third page area of the target page, a first data indicator item 601, a second data indicator item 602, first indicator data 603 of the first indicator item 601 being presented in the third page area of the target page and a data trend graph 604 corresponding to the first data indicator item 601 are displayed. If a trigger operation of switching from the first data indicator item 601 to the second data indicator item 602 is received, the first indicator data 603 is switched to display the second indicator data 605 corresponding to the current playback time point, and the data trend graph 604 corresponding to the first data indicator item 601 is also switched to display the data trend graph 606 corresponding to the second data indicator item 602. The second indicator data 605 belongs to the second data indicator item 602.

In practical, on the basis of including the third page area on the target page, the playback time axis of the target video may be displayed in the third page area.

In the target page shown in FIG. 6, the playback time axis of the target video is displayed in the third page area.

The method for video processing provided by embodiments of the present disclosure facilitates the user to conveniently browse the fragment information corresponding to each target video fragment in the process of watching the target video, thereby enriching video processing-related functions and improving user experience.

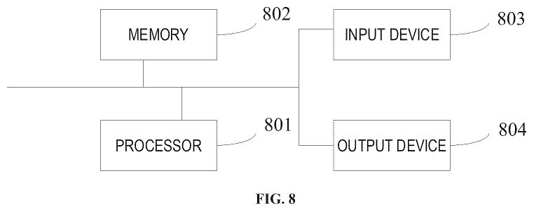

Based on the foregoing embodiments of the method, the present disclosure further provides an apparatus for video processing. FIG. 7 is a schematic structural diagram of an apparatus for video processing provided for an embodiment of the present disclosure. The apparatus includes:
a first display module 701 configured for displaying a target page, the target page including a first page area and a second page area; and
a first presentation module 702 configured for playing a target video in the first page area and presenting at least one fragment information corresponding to the target video in the second page area. Each of the fragment information has a correspondence with a target video fragment in the target video. The fragment information corresponding to the target video fragment reflects content attribute information of a preset type of the target video fragment.

In an optional implementation, the apparatus further includes:
a first adjusting module configured for adjusting, in response to the target video being played to a first target video fragment, a display position of first fragment information corresponding to the first target video fragment to a first target presentation position in the second page area.

In an optional implementation, the apparatus further includes:
a second adjusting module configured for adjusting, in response to a preset trigger operation for second fragment information in the second page area, a playback progress of the target video in the first page area to a second target video fragment corresponding to the second fragment information.

In an optional implementation, the second adjusting module is specifically configured to:
in response to the preset trigger operation for the second fragment information in the second page area, adjusting a display position of the second fragment information to a second target presentation position in the second page area, and adjusting the playback progress of the target video in the first page area to the second target video fragment corresponding to the second fragment information.

In an optional implementation, the content attribute information of the preset type comprises fragment description information and/or fragment interpretation information of the target video fragment, the fragment description information describing an attribute feature of the target video fragment, and the fragment interpretation information reflecting a content feature of the target video fragment,

wherein the fragment description information comprises at least one of playback time information, a video picture, or video interaction data of the target video fragment,

wherein the fragment interpretation information comprises fragment digest information corresponding to the target video fragment and/or object description manner information corresponding to the target video fragment, wherein the fragment digest information is obtained by performing digest extraction on target text information, the target text information being obtained by performing speech recognition on the target video fragment, or the fragment digest information is text information obtained by performing speech recognition on the target video fragment, the object description manner information representing a description manner of a recommended object in the target video fragment.

In an optional implementation, the playback time information comprises playback start and end times of the target video fragment, and/or
the video picture comprises an initial frame video picture in the target video fragment, and/or
the video interaction data comprises an amount of user views and/or user usage, and/or
the fragment digest information comprises target text content displayed in a preset manner, the target text content describing a feature of the recommended object in the target video fragment.

In an optional implementation, the target page further includes a third page area, and the apparatus further includes:
a second display module configured for displaying a current playback time point of the target video and first indicator data corresponding to the current playback time point in the third page area, wherein the first indicator data belongs to a first data indicator item.

In an optional implementation, a data trend graph corresponding to the first data indicator item is presented within the third page area, the data trend graph reflecting a data change status of the target video for the first data indicator item.

In an optional implementation, a plurality of data indicator items is presented within the third page area, and the apparatus further includes:
a switching display module configured for switching, in response to a trigger operation to switch from the first data indicator item to a second data indicator item, the first indicator data in the third page area to display second indicator data corresponding to the current playback time point of the target video, wherein the second indicator data belongs to the second data indicator item.

In an optional implementation, a playback time axis of the target video is displayed on the target page, and a playback start time point corresponding to the target video fragment in the target video is marked on the playback time axis, and/or

the target video fragments corresponding to respective fragment information presented in the second page area are different, and/or

the target video fragment is a video fragment of which target indicator data meets a preset condition, the target indicator data being determined based on indicator data of a preset type during a playback period of the video fragment.

In the apparatus for video processing provided by embodiments of the present disclosure, a target page comprising a first page area and a second page area is displayed, a target video in the first page area is played, and at least one fragment information corresponding to the target video is presented in the second page area. The fragment information presented in the second page area has a correspondence with a target video fragment in the target video. Therefore, in the process of playing the target video on the target page, embodiments of the present disclosure can present the fragment information corresponding to each target video fragment in the target video on the same page. Based on this, embodiments of the present disclosure facilitate the user to browse the fragment information corresponding to each target video fragment in the process of watching the target video, thereby enriching video processing-related functions and improving user experience.

In addition to the foregoing method and apparatus, embodiments of the present disclosure further provide a computer-readable storage medium. The computer-readable storage medium stores an instruction. When the instruction runs on a terminal device, causing a terminal device to implement the method for video processing according to embodiments of the present disclosure.

Embodiments of the present disclosure further provide a computer program product, where the computer program product includes a computer program/instruction. The computer program/instruction, when executed by a processor, implements the method for video processing according to embodiments of the present disclosure.

In addition, an embodiment of the present disclosure further provides a device for video processing, as shown in FIG. 8, which may include:
a processor 801, a memory 802, an input device 803, and an output device 804. There may be one or more processors 801 in the device for video processing, and one processor is taken as an example in FIG. 8. In some embodiments of the present disclosure, the processor 801, the memory 802, the input device 803, and the output device 804 may be connected through a bus or other manners, and FIG. 8 is an example of a connection through a bus.

The memory 802 may be configured to store software programs and modules, and the processor 801 executes various functional applications and data processing of the video processing device by running the software programs and modules stored in the memory 802. The memory 802 may mainly include a storage program area and a storage data area. The storage program area may store an operating system, an application program required by at least one function, and the like. In addition, the memory 802 may include a high-speed random access memory, or may include a non-volatile memory, for example, at least one magnetic disk storage device, a flash memory device, or other volatile solid-state storage device. The input device 803 may be configured to receive input numeric or character information, and generate signal input related to user setting and function control of the video processing device.

Specifically, in this embodiment, the processor 801 loads an executable file corresponding to the process of one or more application programs into the memory 802 according to the following instruction, and runs the application programs stored in the memory 802 by the processor 801, thereby implementing various functions of the foregoing video processing device.

It is to be noted that, in this specification, relational terms such as “first” and “second” are merely used to distinguish one entity or operation from another entity or operation, and do not necessarily require or imply that any such actual relationship or sequence exists between these entities or operations. Moreover, the terms “including”, “comprising” or any other variation thereof are intended to cover a non-exclusive inclusion, such that a process, method, article, or device comprising a series of elements includes not only those elements, but also other elements not expressly listed, or elements inherent to this process, method, article, or device. Without further restriction, the elements defined by the statement “include one . . . ” do not preclude the existence of additional identical elements in the process, method, article, or device that includes the elements.

The above descriptions are only specific embodiments of the present disclosure, so that those skilled in the art can understand or implement the present disclosure. Various modifications to these embodiments will be apparent to those skilled in the art, the general principles defined herein may be implemented in other embodiments without departing from the spirit or scope of the present disclosure. Accordingly, the present disclosure will not be limited to these embodiments described herein, but is to be conformed to the widest scope consistent with the principles and novel features disclosed herein.

I/we claim:

1. A method for video processing, comprising:
displaying a target page, wherein the target page includes a first page area and a second page area; and
playing a target video in the first page area and presenting at least one fragment information corresponding to the target video in the second page area, wherein each of the fragment information has a correspondence with a target video fragment in the target video, the fragment information corresponding to the target video fragment reflecting content attribute information of a preset type of the target video fragment.

2. The method of claim 1, further comprising:
adjusting, in response to the target video being played to a first target video fragment, a display position of first fragment information corresponding to the first target video fragment to a first target presentation position in the second page area.

3. The method of claim 1, further comprising:
adjusting, in response to a preset trigger operation for second fragment information in the second page area, a playback progress of the target video in the first page area to a second target video fragment corresponding to the second fragment information.

4. The method of claim 3, wherein adjusting, in response to a preset trigger operation for second fragment information in the second page area, a playback progress of the target video in the first page area to a second target video fragment corresponding to the second fragment information comprises:
in response to the preset trigger operation for the second fragment information in the second page area, adjusting a display position of the second fragment information to a second target presentation position in the second page area, and adjusting the playback progress of the target video in the first page area to the second target video fragment corresponding to the second fragment information.

5. The method of claim 1, wherein the content attribute information of the preset type comprises fragment description information and/or fragment interpretation information of the target video fragment, the fragment description information describing an attribute feature of the target video fragment, and the fragment interpretation information reflecting a content feature of the target video fragment,
wherein the fragment description information comprises at least one of playback time information, a video picture, or video interaction data of the target video fragment,
wherein the fragment interpretation information comprises fragment digest information corresponding to the target video fragment and/or object description manner information corresponding to the target video fragment, wherein the fragment digest information is obtained by performing digest extraction on target text information, the target text information being obtained by performing speech recognition on the target video fragment, or the fragment digest information is text information obtained by performing speech recognition on the target video fragment, the object description manner information representing a description manner of a recommended object in the target video fragment.

6. The method of claim 5, wherein:
the playback time information comprises playback start and end times of the target video fragment, and/or
the video picture comprises an initial frame video picture in the target video fragment, and/or
the video interaction data comprises an amount of user views and/or user usage, and/or
the fragment digest information comprises target text content displayed in a preset manner, the target text content describing a feature of the recommended object in the target video fragment.

7. The method of claim 1, wherein the target page further comprises a third page area, and the method further comprises:
displaying a current playback time point of the target video and first indicator data corresponding to the current playback time point in the third page area, wherein the first indicator data belongs to a first data indicator item.

8. The method of claim 7, wherein a data trend graph corresponding to the first data indicator item is presented within the third page area, the data trend graph reflecting a data change status of the target video for the first data indicator item.

9. The method of claim 7, wherein a plurality of data indicator items is presented within the third page area, and the method further comprises:
switching, in response to a trigger operation to switch from the first data indicator item to a second data indicator item, the first indicator data in the third page area to display second indicator data corresponding to the current playback time point of the target video, wherein the second indicator data belongs to the second data indicator item.

10. The method of claim 1, wherein:
a playback time axis of the target video is displayed on the target page, and a playback start time point corresponding to the target video fragment in the target video is marked on the playback time axis, and/or
the target video fragments corresponding to respective fragment information presented in the second page area are different, and/or
the target video fragment is a video fragment of which target indicator data meets a preset condition, the target indicator data being determined based on indicator data of a preset type during a playback period of the video fragment.

11. A non-transitory computer-readable storage medium, wherein the computer-readable storage medium stores an instruction, when the instruction runs on a terminal device, causing the terminal device to implement a method comprising:
displaying a target page, wherein the target page includes a first page area and a second page area; and
playing a target video in the first page area and presenting at least one fragment information corresponding to the target video in the second page area, wherein each of the fragment information has a correspondence with a target video fragment in the target video, the fragment information corresponding to the target video fragment reflecting content attribute information of a preset type of the target video fragment.

12. The non-transitory computer readable storage medium of claim 11, further comprising:
adjusting, in response to the target video being played to a first target video fragment, a display position of first fragment information corresponding to the first target video fragment to a first target presentation position in the second page area.

13. The non-transitory computer readable storage medium of claim 11, further comprising:
adjusting, in response to a preset trigger operation for second fragment information in the second page area, a playback progress of the target video in the first page area to a second target video fragment corresponding to the second fragment information.

14. The non-transitory computer readable storage medium of claim 13, wherein adjusting, in response to a preset trigger operation for second fragment information in the second page area, a playback progress of the target video in the first page area to a second target video fragment corresponding to the second fragment information comprises:
in response to the preset trigger operation for the second fragment information in the second page area, adjusting a display position of the second fragment information to a second target presentation position in the second page area, and adjusting the playback progress of the target video in the first page area to the second target video fragment corresponding to the second fragment information.

15. The non-transitory computer readable storage medium of claim 11, wherein the content attribute information of the preset type comprises fragment description information and/or fragment interpretation information of the target video fragment, the fragment description information describing an attribute feature of the target video fragment, and the fragment interpretation information reflecting a content feature of the target video fragment,
wherein the fragment description information comprises at least one of playback time information, a video picture, or video interaction data of the target video fragment,
wherein the fragment interpretation information comprises fragment digest information corresponding to the target video fragment and/or object description manner information corresponding to the target video fragment, wherein the fragment digest information is obtained by performing digest extraction on target text information, the target text information being obtained by performing speech recognition on the target video fragment, or the fragment digest information is text information obtained by performing speech recognition on the target video fragment, the object description manner information representing a description manner of a recommended object in the target video fragment.

16. The non-transitory computer readable storage medium of claim 15, wherein:
the playback time information comprises playback start and end times of the target video fragment, and/or
the video picture comprises an initial frame video picture in the target video fragment, and/or
the video interaction data comprises an amount of user views and/or user usage, and/or
the fragment digest information comprises target text content displayed in a preset manner, the target text content describing a feature of the recommended object in the target video fragment.

17. The non-transitory computer readable storage medium of claim 11, wherein the target page further comprises a third page area, and the method further comprises:
displaying a current playback time point of the target video and first indicator data corresponding to the current playback time point in the third page area, wherein the first indicator data belongs to a first data indicator item.

18. The non-transitory computer readable storage medium of claim 17, wherein a data trend graph corresponding to the first data indicator item is presented within the third page area, the data trend graph reflecting a data change of the target video for the first data indicator item.

19. The non-transitory computer readable storage medium of claim 17, wherein a plurality of data indicator items is presented within the third page area, and the method further comprises:
switching, in response to a trigger operation to switch from the first data indicator item to a second data indicator item, the first indicator data in the third page area to display second indicator data corresponding to the current playback time point of the target video, wherein the second indicator data belongs to the second data indicator item.

20. A device for video processing, comprising: a memory, a processor, and a computer program stored in the memory and executable on the processor, the processor executing the computer program to implement acts comprising:
displaying a target page, wherein the target page includes a first page area and a second page area; and
playing a target video in the first page area and presenting at least one fragment information corresponding to the target video in the second page area, wherein each of the fragment information has a correspondence with a target video fragment in the target video, the fragment information corresponding to the target video fragment reflecting content attribute information of a preset type of the target video fragment.
